(19) United States
(12) Patent Application Publication
(10) Pub. No.: US 2020/0374310 A1
(43) Pub. Date: Nov. 26, 2020

(54) PROTECTION FROM NETWORK INITIATED ATTACKS

(71) Applicant: Intel Corporation, Santa Clara, CA (US)

(72) Inventors: Amruta MISRA, Bangalore (IN); John J. BROWNE, Limerick (IE); Chris MACNAMARA, Limerick (IE)

(21) Appl. No.: 16/990,684

(22) Filed: Aug. 11, 2020

(51) Int. Cl. H04L 29/06

(52) U.S. Cl. CPC H04L 63/1425; H04L 63/1416; H04L 69/166; H04L 63/0236; H04L 63/1458

(57) ABSTRACT

Examples described herein relate to a computing system that alters a frequency of operation of a peripheral device interface between a network interface card and a processor based on detection of a traffic violation. In some examples, a frequency of operation of a peripheral device interface is reduced based on detection of a traffic violation. In some examples, IP packet fragments can include one or more of: IP packet fragments that are incomplete packets, IP packet fragment that are too small, IP packet fragments that result in excessive packets, or IP packet fragmentation buffer being full. In some examples, detecting a traffic violation is based on detection of IP packet fragments at one or more of: a network appliance, the network interface card, uncore, system agent, operating system, application, or a computing platform. In some examples, the peripheral device interface includes one or more of: a system agent, an uncore, a bus, a device interface, and a cache. In some examples, the peripheral device interface is part of a system on a chip (SoC) and the SoC also includes one or more of: a core, system agent, or uncore.

Network Functions (NF) and Virtual Network Functions (VNFs) performing high speed data plane and signaling processing can be flooded with network traffic, causing the VNF to become overloaded and causing the virtualized applications to become congested and unresponsive. Sources of network flooding can include signaling storms generated in the network. High compute resources are required to process the signaling storm, which can cause the processors to become overloaded and unavailable to perform other work. Some sources of network flooding can include malicious network attack vectors include Denial of Service (DoS) attacks using fragment attacks and buffer-based attacks and distributed versions of these types of attacks (e.g., distributed denial-of-service (DDoS)).

### BRIEF DESCRIPTION OF THE DRAWINGS

FIG. 1 depicts an example system.

FIG. 2 depicts an example system.

FIG. 3A depicts an example system.

FIG. 3B depicts an example pipeline for packet filtering for packet fragments.

FIG. 4 depicts an example process.

FIG. 5A depicts an example process.

FIG. 5B depicts examples of manners of modifying frequency of operation of an uncore or system agent.

FIG. 6 depicts a system.

FIG. 7 depicts an example environment.

FIG. 8 depicts an example network interface.

### DETAILED DESCRIPTION

In some solutions, in connection with an overflow of received packets, receive queues processed by a central processing unit (CPU) are allowed to become full and the CPU can process the packets. Packets can be discarded or blocked in some cases or input ports of an input/output (10) device can be disabled to prevent receipt of more traffic. In some solutions, access control list (ACL) policies can be applied in a network interface card (NIC) or in host software. However, additional processor resources may not be available to process received packets or apply ACL when severe overload occurs. In addition, indiscriminate discard can occur of high priority or critical packets (e.g., failover protocol traffic, routing table updates, heartbeats) due to the timing window between when overload is detected and when the discard policy is applied.

In case of a network security attack, malicious inputs target an application or service. The attackers can interrupt and gain control of an application or machine. Following a successful exploit, the attacker can disable the target application (resulting in a denial-of-service state), disable physical ports or virtual ports in the case of a router or switch, exhausting resources such as memory buffers, exceeding queue depths, or can potentially access to all the rights and permissions available to the compromised application.

A network appliance or software such as an Intrusion Prevention System (IPS) examines network traffic flows to detect and prevent vulnerability exploits. IPS can execute in a communication path between a source and destination and the IPS can actively analyze received packets and take automated actions on all traffic flows that enter the network. In a case of detected malicious attack, independent messaging can be used to send an alarm to a data center administrator. In connection with CPU overload, IPS can drop the packets deemed malicious, block traffic from the source address, or reset a connection with a source or sender. The system administrator can be forced to shut down the system, if mitigation efforts are unsuccessful or lead to unacceptable results. However, the mitigation actions lead to degrading network performance, stall of system and may not respond to real-time activity soon enough.

Various embodiments attempt to address a flood of received packets by modifying uncore or system agent frequency as a congestion controller at the entry point of packets for processing by a processor. For example, in an event of flood of received packets, power or frequency allocated to the uncore or system agent can be reduced and, optionally, additional power or frequency can be made available to CPU cores to process packets, such as a backlog of packets. In some embodiments, an uncore or system agent can provide a device interface between one or more CPU cores and a network interface card. Reducing a frequency of operation of the uncore or system agent can reduce a rate at which received packets are copied or transferred from a network interface card (NIC) to a cache or other memory for processing by a CPU core or other devices (e.g., accelerator or graphics processing unit (GPU)). For example, a NIC or other interface can be connected to CPU cores via the uncore or system agent using any version of peripheral component interconnect express (PCIe) interfaces. Slowing an uncore or system agent frequency can slow a rate at which received packets are copied from the NIC but can slow a packet transmit rate. In cases where packet flooding is reduced or a processor can adequately handle the packet flooding, the uncore or system agent frequency of operation can be increased to a higher level but lower than its default frequency or to a default frequency. Various embodiments can be used to provide additional protection against attacks using DDoS attacks in a 5G network core and edge and maintain CPU availability during network based attacks.

In some examples, a frequency of operation of an uncore or system agent can be set using a register (e.g., model specific register (MSR)). For example, a power management controller (e.g., firmware) can adjust a frequency of operation of the uncore or system agent. If reducing the frequency of operation of the uncore or system agent increases an amount of available power to the cores or there is available power to provide to one or more cores, the power management controller can increase power allocated to cores. For example, an IPS can request the power management controller to reduce a frequency of operation of the uncore or system agent.

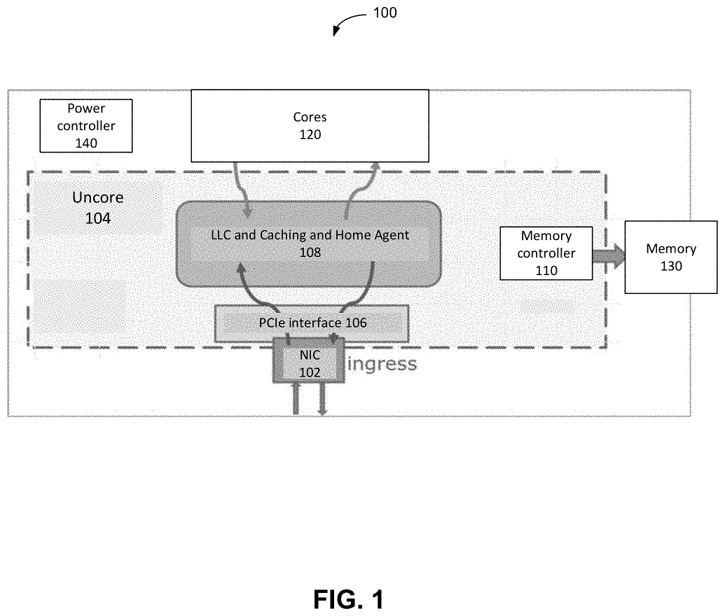

FIG. 1 shows an example path of network traffic from a network interface card (NIC) to cores. In system 100, a network packet received at NIC 102 can be sent using a message transaction between uncore 104 and NIC 102 before processing by cores 120. Message transactions between NIC 102 and cores 120 can use components of uncore 104. Uncore 104 can include circuitry outside of CPU cores 120 but residing on the same die such as L3 cache, integrated memory controller, UltraPath Interconnect (UPI), and an interconnect-mesh.

For example, where a PCIe interface is used, PCIe interface 106 can provide communications of received packets from NIC 102 at least to last level cache (LLC) and caching and home agent (CHA) 108. Note that LLC and CHA can be integrated or separate components. The CHA can serve as a local coherence and cache controller and serve as a coherence and interface to memory controller 110. In some embodiments, CHA couples to LLC and CHA can attempt to maintain cache coherency among different memory and cache devices in other clusters or CPU sockets. For example, a core can send a memory access request to its CHA and CHA can provide data from its cache slice or obtain a copy of data from another core's cache.

Various embodiments detect packet flooding and to prevent or mitigate overload of utilization of cores 120 and LLC and CHA 108, various embodiments can reduce an uncore frequency to manage congestion at an entry point of packets from NIC 102 for processing by cores 120. For example, in response to detection of possible packet flooding, an IPS (not shown) can request power controller 140 to reduce a frequency of operation of uncore 104. In some examples, power controller 140 can increase a frequency of operation of any of cores 120, if there is available power budget, to process a backlog of packets.

In some examples, any of cores 120 can execute an application, workload, or software that performs packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in virtualized execution environments (VEEs) (e.g., containers or virtual machines). VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

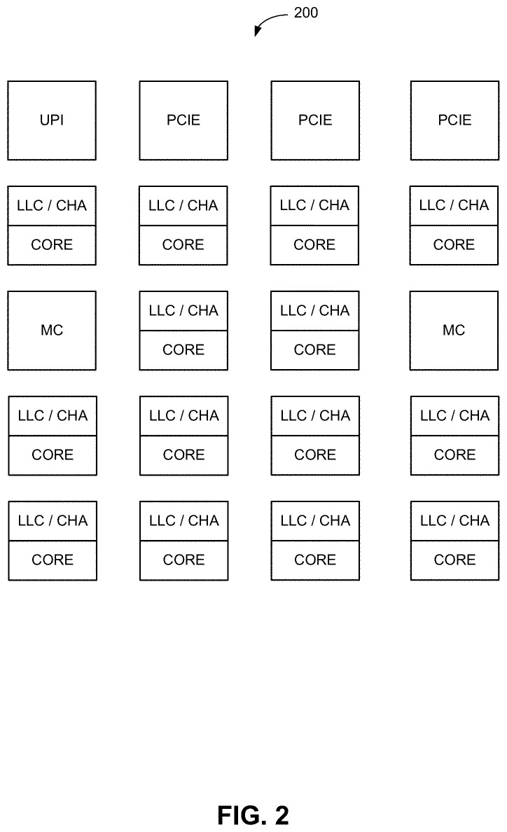

FIG. 2 depicts an example system. System 200 depicts an example layout of interfaces (e.g., UPI and PCIe) with LLC/CHA (e.g., uncore) and cores as well as memory controller (MC). A mesh can be used to provide connectivity between various devices of system 200. Any layout of interfaces, uncore and cores can be used and any number of interfaces, uncores, cores and MC can be used.

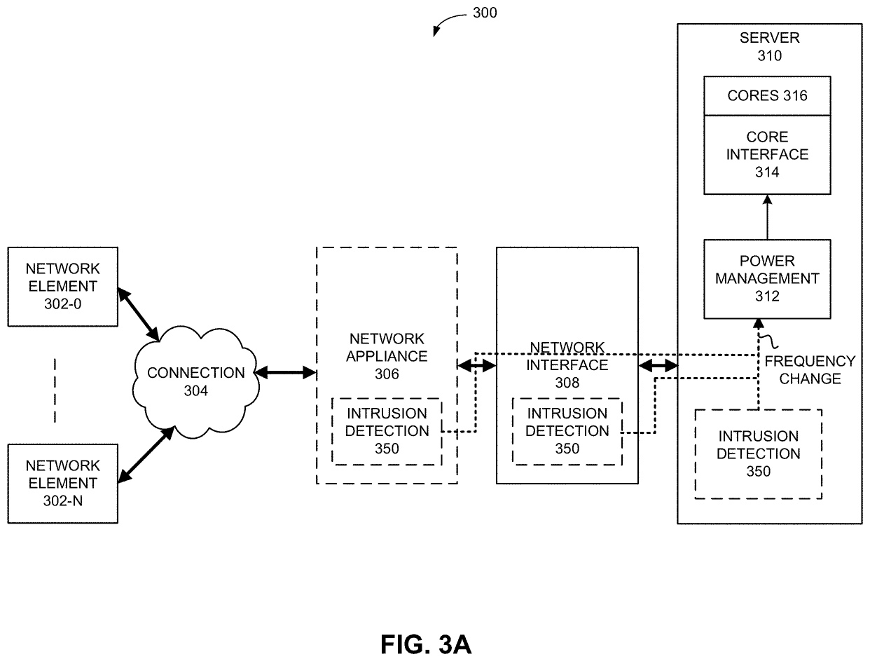

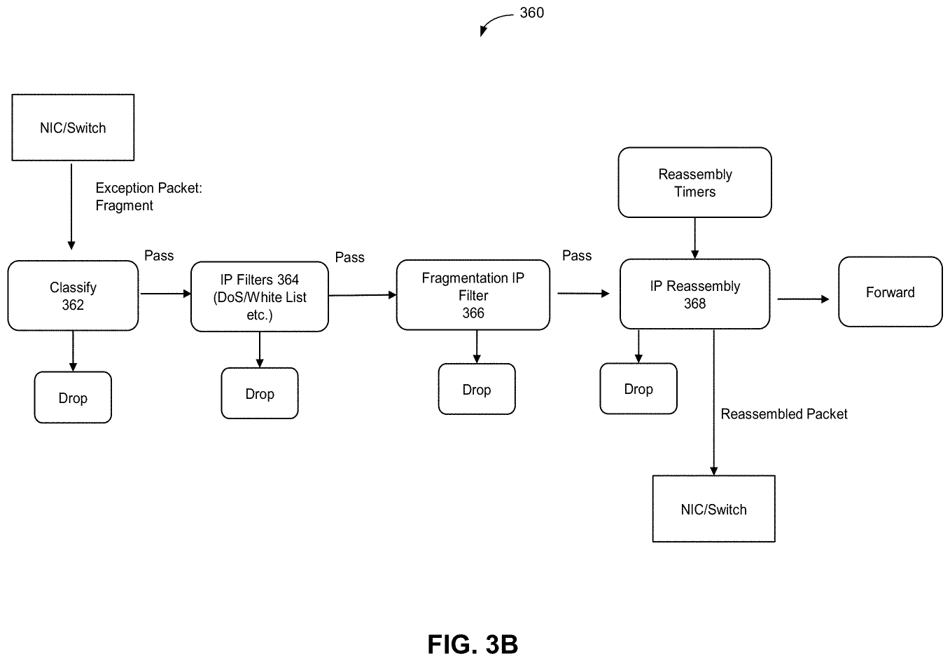

FIG. 3A depicts an example system. In this example, network elements 302-0 to 302-N (where N is an integer and is 1 or more) can be communicatively coupled to server 310 using network interface 308 over connection 304. Any of network elements 302-0 to 302-N and network interface 308 can include a network interface (e.g., network interface card or network interface controller), bus interface, fabric interface, switch, router, forwarding element, and so forth). Connection 304 can be compatible at least with any networking or communication standard including Ethernet, InfiniBand, Compute Express Link (CXL), HyperTransport, any high-speed fabric, PCIe, NVLink, Advanced Microcontroller Bus Architecture (AMBA) interconnect, OpenCAPI, Gen-Z, CCIX, Intel® QuickPath Interconnect (QPI), Intel® Ultra Path Interconnect (UPI), Intel® On-Chip System Fabric (IOSF), Omnipath, and so forth. Server 310 can refer to any computing platform, such as a server, rack, edge computing node, or data center.

In some examples, intrusion detection system 350 examines network traffic flows to detect vulnerability exploits or other efforts to flood network interface 308 or cores 316 with packets to process. Intrusion detection system 350 can protect against critical networking infrastructure from Denial of Service (DoS) attacks and Distributed Denial of Service (DDoS) attacks based on fragmented packets, improving uptime and network service level agreements (SLAs). For example, intrusion detection system 350 can detect and attempt to protect against at least the following types of attacks: tiny fragment attack, buffer overflow attack, or overlapping fragment attack.

A tiny fragment attack can involve an attacker or sender setting a fragment size small enough to force Layer 4 (e.g., TCP and UDP) header fields into a second fragment. A buffer overflow attack can be a denial-of-service (DoS) attack where the attacker or sender can continuously send a large number of incomplete IP fragments, to consume time and memory because the server 310 attempts to reassemble the fake packets. An overlapping fragment attack can involve an attacker or sender overwrite the fragment offset in non-initial IP fragment packets so that when the forwarding plane reassembles the IP fragments, it might create wrong IP packets, causing the memory to overflow or the system to reload.

For example, RFC 1858 (1995) discusses security considerations for IP fragment filtering and highlights two attacks on hosts that involve IP fragments of TCP packets: the Tiny Fragment Attack and the Overlapping Fragment Attack. Blocking these attacks is desirable because they can compromise a host, or tie up all of its internal resources. RFC 1858 also describes two methods of defending against these attacks, the direct and the indirect. In the direct method, initial fragments that are smaller than a minimum length are discarded. The indirect method involves discarding the second fragment of a fragment set, if it starts 8 bytes into the original IP datagram.

Intrusion detection system 350 can apply IP filter rules before fragment processing (e.g., at OS). For detected tiny fragment, intrusion detection system 350 can drop the packet. For detected overlapping fragment attack, intrusion detection system 350 can drop all fragments within a fragment chain if an overlap fragment is detected.

To detect buffer overflow attack, intrusion detection system 350 can track a maximum threshold for the number of IP datagrams that are being reassembled and number of fragments per datagram and perform: (1) when the maximum number of fragments per datagram is reached, subsequent fragments are dropped and the global statistics COUNTER is incremented by one; (2) in addition to a maximum threshold values being configured, each IP datagram is associated with a managed timer; (3) if the IP datagram does not receive all of the fragments within the specified time, the timer expires and the IP datagram and all of its fragments are dropped; (4) when the maximum number of datagrams that can be reassembled at any given time is reached, all subsequent fragments are dropped, and the global statistics COUNTER is incremented by one.

In some examples, intrusion detection system 350 can be executed in any of a network appliance 306, network interface 308, and/or server 310 (e.g., operating system, application, or core interface 314). For example, network appliance 306 can receive packets from connection 304 that are to be forwarded to network interface 308. In some examples, network appliance 306 can execute intrusion detection system 350 to detect DoS or DDoS attacks intended for network interface 308 or server 310 and attempt to mitigate packet overflow arising from attacks at network interface 308 and server 310.

In some examples, intrusion detection system 350 can enforce an access control list (ACL) to discard packets associated with certain flows deemed malicious. A flow can be a sequence of packets being transferred between two endpoints, generally representing a single session using a known protocol. Accordingly, a flow can be identified by a set of defined N tuples and, for routing purpose, a flow can be identified by tuples that identify the endpoints, e.g., the source and destination addresses. For content based services (e.g., load balancer, firewall, intrusion detection system etc.), flows can be identified at a finer granularity by using five or more tuples (e.g., source address, destination address, IP protocol, transport layer source port, and destination port). A packet in a flow is expected to have the same set of tuples in the packet header.

According to various embodiments, in response to detection of an intrusion attempt, intrusion detection system 350 (e.g., IPS) can issue a frequency change notice, flag, indicator or message to power management 312 to request adjustment of a frequency of core interface 314 between a network interface 314 and core 316. For example, core interface 314 can include an uncore or system agent that provides an interface between network interface 308 and cores 316. In some examples, the uncore or system agent can include a bus interface (e.g., PCIe), a cache and a caching and home agent. In a case of detection of vulnerability identified by intrusion detection system 350, intrusion detection system 350 can request power management 312 to reduce the frequency of operation of core interface 314 as a gate to control the messaging speed between network interface 308 and cores 316. For example, lowering frequency of operation of the uncore can protect the server 310 and cores 316 from being overloaded by received messages and slow down message transfers between cores 316 and network interface 308.

In scenarios where intrusion detection system 350 detects an attack (e.g., DoS or DDoS) has subsided for a particular flow or flows, intrusion detection system 350 can inform power management 312 to increase a frequency of core interface 314 via a frequency change message, indicator, or flag. In case of detection of a vulnerability no longer being active, intrusion detection system 350 can attempt to increase an operating frequency of core interface 314 in steps or to a prior frequency level. For example, the operating frequency of core interface 314 can be increased if intrusion detection system 350 detects that CPU completes processing the packets in the backlog. In response to the request to increase frequency of core interface 314, power management 312 can attempt to reduce a frequency of a core if power budget is not available with an increase in frequency of core interface 314. Note that power management 312 can adjust (e.g., increase or reduce) power available to devices other than cores such as accelerators, media processors, video offload engine, decryption/encryption offload engines, network interface cards, graphics processing units (GPUs), and so forth.

In some examples, core interface 314 and cores 316 can operate on separate variable voltage and frequency domains. This allows the system to take advantage of all the benefits of a variable uncore domain, while allowing for improved power efficiency. For a given power budget, lowering of frequency of core interface 314 can allow extra head room for higher frequency of operation of cores 316. A higher core frequency can help with performing preventive actions prescribed from intrusion detection system 350 or an operating system (OS).

In some examples, a core can be an execution core or computational engine that is capable of executing instructions. A core can have access to its own cache and read only memory (ROM), or multiple cores can share a cache or ROM. Cores can be homogeneous and/or heterogeneous devices. Any type of inter-processor communication techniques can be used, such as but not limited to messaging, inter-processor interrupts (IPI), inter-processor communications, and so forth. Cores can be connected in any type of manner, such as but not limited to, bus, ring, or mesh.

In some examples, an uncore or system agent can include or more of a memory controller, a shared cache (e.g., LLC), a cache coherency manager, arithmetic logic units, floating point units, core or processor interconnects, or bus or link controllers (e.g., PCIe interface). System agent can provide one or more of: direct memory access (DMA) engine connection, non-cached coherent master connection, data cache coherency between cores and arbitrates cache requests, or Advanced Microcontroller Bus Architecture (AMBA) capabilities.

In some examples, power management 312 can adjust frequency of operation of cores 316, core interface 314, and other devices independently by setting values in registers such as model specific register (MSR). For example, MSR can include control registers used for program execution tracing, toggling of compute features, and/or performance monitoring. The MSR can include one or more of: memory order buffer (MOB) control and status; page fault error codes; clearing of page directory cache and translation lookaside buffer (TLB) entries; control of the various cache memories in the cache hierarchy of the microprocessor, such as disabling portions or all of a cache, removing power from portions or all of a cache, and invalidating cache tags; microcode patch mechanism control; debug control; processor bus control; hardware data and instruction pre-fetch control; power management control, such as sleep and wakeup control, state transitions as defined by Advanced Configuration and Power Interface (ACPI) industry standards (e.g., P-states and C-states), and disabling clocks or power to various functional blocks; control and status of instruction merging; Error-correcting code (ECC) memory error status; bus parity error status; thermal management control and status; service processor control and status; inter-core communication; inter-die communication; functions related to fuses of the microprocessor; voltage regulator module voltage identifier control; phase lock loop (PLL) control; cache snoop control; write-combine buffer control and status; overclocking feature control; interrupt controller control and status; temperature sensor control and status; enabling and disabling of various features, such as encryption/decryption, MSR password protection, making parallel requests to the L2 cache and the processor bus, individual branch prediction features, instruction merging, microinstruction timeout, performance counters, store forwarding, and speculative table walks; load queue size; cache memory size; control of how accesses to undefined MSRs are handled; multi-core configuration; configuration of a cache memory (e.g., de-selecting a column of bit cells in a cache and replacing the column with a redundant column of bit cells), duty cycle and/or clock ratio of phase-locked loops (PLLs) of the microprocessor, and the setting voltage identifier (VID) pins that control a voltage source to the microprocessor.

FIG. 3B depicts an example pipeline for packet filtering for packet fragments. A NIC or switch or other device or software (e.g., IPS) can detect a packet fragment. Collectively, classify 362, IP filters 364, fragmentation IP filter 366, and IP reassembly 368 can identify if a packet is part of a tiny fragment attack, buffer overflow attack, or overlapping fragment attack and drop the packet if the packet is considered part of a tiny fragment attack, buffer overflow attack, or overlapping fragment attack. If the packet is not considered part of a tiny fragment attack, buffer overflow attack, or overlapping fragment attack, IP reassembly 368 can reassemble a packet and provide the reassembled packet to a NIC or switch or forward the reassembled packet to a server.

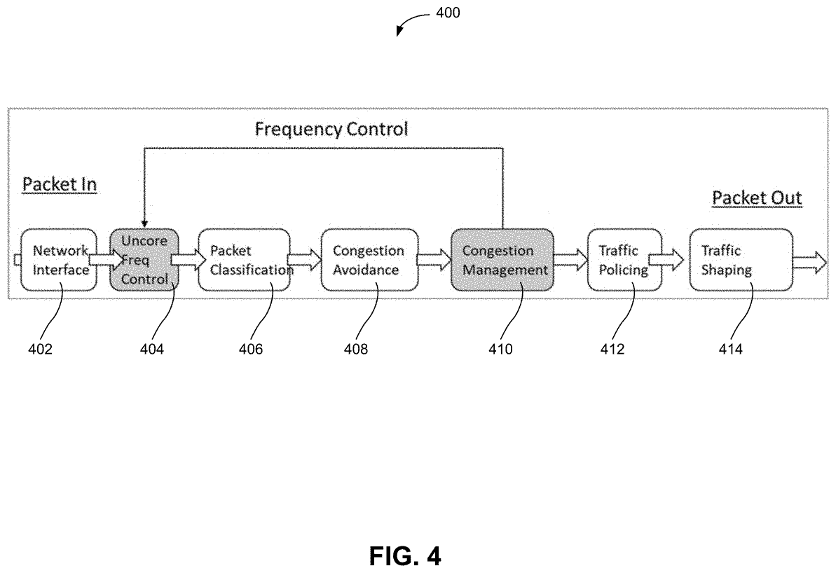

FIG. 4 depicts an example process. At 402, a network interface (e.g., NIC, network interface controller, fabric interface, and so forth) can receive a packet from a connection. A system agent or uncore can communicatively couple and transfer packet content from the network interface to one or more cores. At 404, a frequency of an uncore can be adjusted based on direction from a congestion management system. A reduced frequency of operation of the uncore can reduce a rate at which received packets are provided to the cores. An increased frequency of operation of the uncore can increase a rate at which received packets are provided to the cores. At 406, packet classification can occur to determine if any DoS or DDoS attacks occurred based on a number of detected fragmented packets over an interval of time. For example, DoS or DDoS attacks can be detected based on a number of tiny fragment attacks, buffer overflow attacks, or overlapping fragment attacks that occur within a window of time for a flow or multiple flows.

At 408, a congestion avoidance scheme can occur in order to request congestion management in an event of detected DoS or DDoS attacks. Congestion management can include reducing frequency of an uncore, increasing frequency of operation of a core or processor, allocating additional buffer space for received packets in memory, and so forth. At 410, if congestion management determines a frequency adjustment is to take place due to an attack, the uncore frequency can be reduced by signaling frequency control to uncore frequency control. At 410, if congestion management determines a frequency adjustment is to take place due to passing of an attack or no attack being detected, the uncore frequency can be increased or maintained by signaling frequency control to uncore frequency control.

At 412, traffic policing can occur to regulate traffic bursts. When the traffic rate reaches a configured maximum rate, excess traffic can be dropped (or remarked). At 414, traffic shaping can occur whereby excess packets are retained in a queue and excess packets are scheduled for later transmission over increments of time to provide a smoothed packet output rate. Traffic shaping can regulate the flow of packets going out an interface or sub-interface, matching the packet flow to the speed of the interface, ability to configure Frame Relay traffic shaping (FRTS) using modular quality of service (QoS) command-line interface (CLI) commands, or regulate the flow of packets (on a per-traffic-class basis) going out an interface, matching the packet flow to the speed of the interface. Packets can be provided to a buffer or cache for processing by one or more cores or other devices.

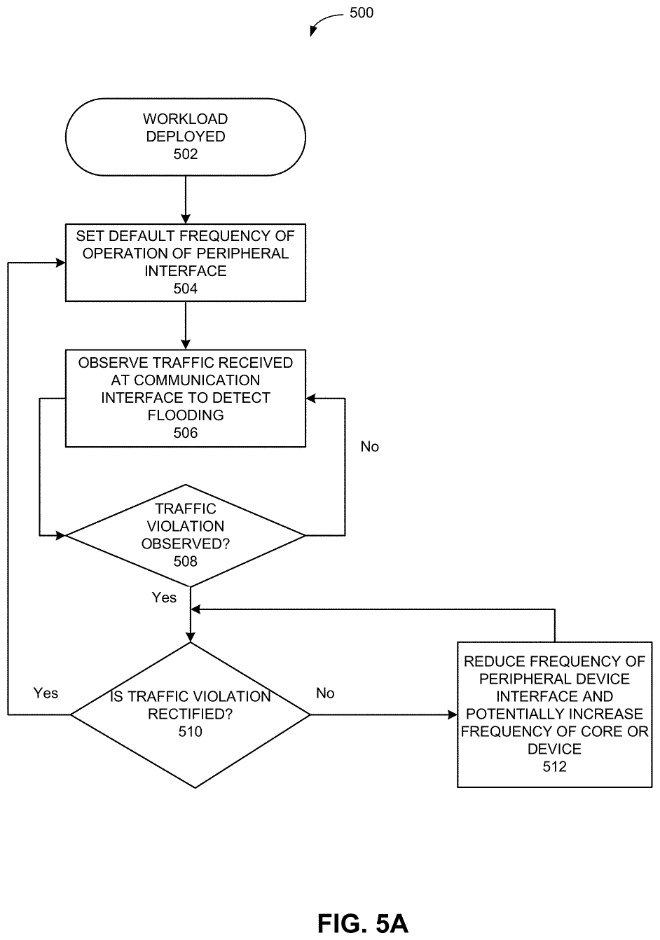

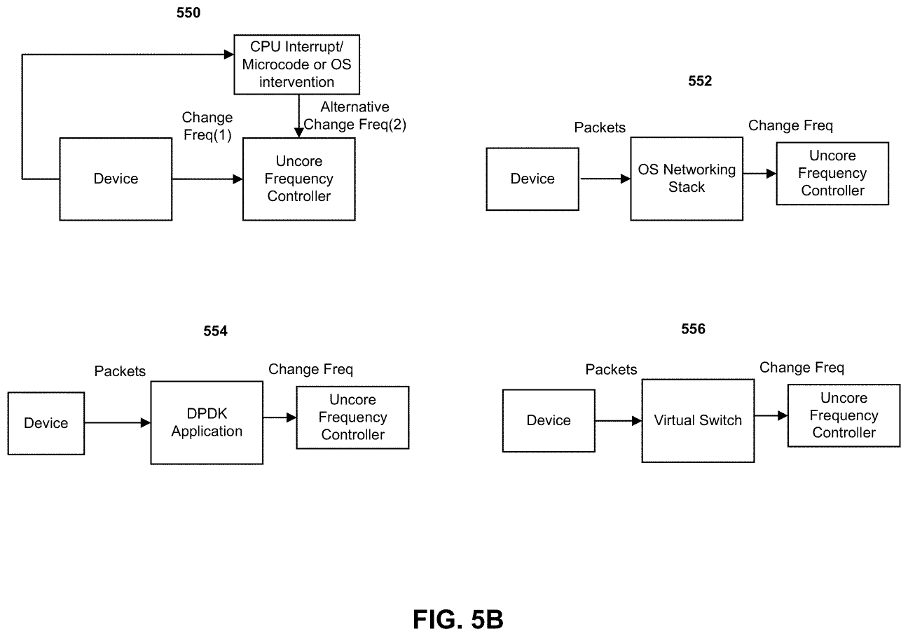

FIG. 5A depicts an example process. At 502, a workload can be deployed on one or more cores or devices for execution. For example, a device can include accelerators, media processors, video offload engine, decryption/encryption offload engines, network interface cards, graphics processing units (GPUs). At 504, a default frequency for an peripheral device interface can be set. For example, the peripheral device interface can include one or more of: a PCIe interface, CXL interface, DDR interface, bus interface, a system agent, an uncore, and/or cache. In some examples, the peripheral device interface can provide communication between a communication interface and a core, processor, or accelerator. The communication interface can include a network interface card, host interface, bus interface, or other communications device that can be subject to malicious or non-malicious flooding of traffic. In some examples, a default clock frequency can be set for the peripheral device interface that can control a rate at which data is transferred from the communication interface to the core, processor, or accelerator. In some examples, increasing a default frequency of operation of the peripheral device interface can lead to less power budget being available for a core or device and the frequency of operation of the core or device can be lowered so that the overall power budget for the peripheral device interface and core and device is not exceeded.

At 506, traffic received at the communication interface can be observed to detect traffic flooding. Traffic flooding can arise from DoS or DDoS attacks on a network interface or server. For example, an IPS or congestion monitor can observe characteristics of packet such as (1) IP packet fragments that are incomplete packets, (2) IP packet fragment that are too small, (3) IP packet fragments that result in excessive packets, (4) IP packet fragmentation buffer being full, or (5) any denial of service (DoS) reported at ingress. For example, the IPS can identify traffic flooding if any of (1) to (5) occur a sufficient number of times over a time interval for a particular flow or flows. For example, traffic flooding can be detected by specific numbers of occurrences of (1) to (4) over a time interval for a particular flow or flows.

At 508, a determination is made of whether a traffic violation occurred. A traffic violation can occur if traffic flooding is detected. If a traffic violation is not observed, the process can return to 506. If a traffic violation is observed, the process can continue to 510.

At 510, a determination is made as to whether the traffic violation has been rectified. IP violation rectification can occur if an OS processes IP packet and drops IP packets deemed to be considered any of (1) to (4) above while maintaining sufficient rate of processing of received packets (e.g., under applicable service level agreement (SLA)) and utilizing an acceptable amount of packet buffer space for received packets (e.g., amount of buffer space does not violate SLA). An operating system or networking software e.g., TCP/IP stack or Berkley packet filters or a networking software application which is processing packets directly from the NIC port such as Data Plane Development Kit (DPDK) or Storage Performance Development Kit (SPDK) based applications can decide if a traffic violation rectified or not. If the traffic violation has been rectified, the process continues to 504, where a frequency of the peripheral device interface can be returned to a default frequency of operation for the peripheral device interface or increased by a step but not to the default frequency of operation for the peripheral device interface.

In some examples, any of 504, 506, 508, or 510 can be performed by network appliance, NIC, ACLs, a processor or circuitry in the uncore or system agent, or processor-executed software (e.g., Linux networking stack, DPDK application, or SPDK application).

If the traffic violation has not been rectified, the process continues to 512. At 512, a frequency of operation of the peripheral device interface can be reduced. The reduction in frequency can be step wise. An amount of frequency reduction can depend on a number of traffic violations without rectification. For a first observed traffic violation without rectification, the reduction can be a step. For a second observed traffic violation without rectification (e.g., second iteration of 510 indicates no), a frequency of the interface can be lowered by a second step that is greater amount than the step. For a third observed traffic violation without rectification (e.g., third iteration of 510 indicates no), a frequency of the interface can be lowered by a greater amount than the second step. However, a lower limit of frequency of operation of the interface can be set for example, where the interface is an uncore or system agent. In addition to lowering frequency of operation of the peripheral device interface, a frequency of operation of a core or device can be increased if there is sufficient power budget available for increasing a frequency of operation of a core or device. The process continues to 510.

FIG. 5B depicts examples of manners of modifying frequency of operation of an uncore or system agent. In scenario 550, a device such as a NIC, FPGA, ASIC, ACL and fragmentation device can detect packet fragments that amount to an attack and (1) request an uncore frequency controller to adjust a frequency or (2) request an OS to adjust a frequency of the uncore. In scenario 552, the device can detect packet fragments that amount to an attack and request an operating system (OS) network stack (e.g., Linux® eBPF or ACL and fragmentation logic) to adjust a frequency of the uncore.

In scenario 554, the device can detect packet fragments that amount to an attack and request a DPDK application (e.g., ACL and fragmentation logic) to adjust a frequency of the uncore. In scenario 556, the device can detect packet fragments that amount to an attack and request a virtual switch (e.g., ACL and fragmentation logic) to adjust a frequency of the uncore. A virtual switch can include vSwitch, VMware® virtual switch (e.g., ESXi), Microsoft® Hyper-V, or Open vSwitch.

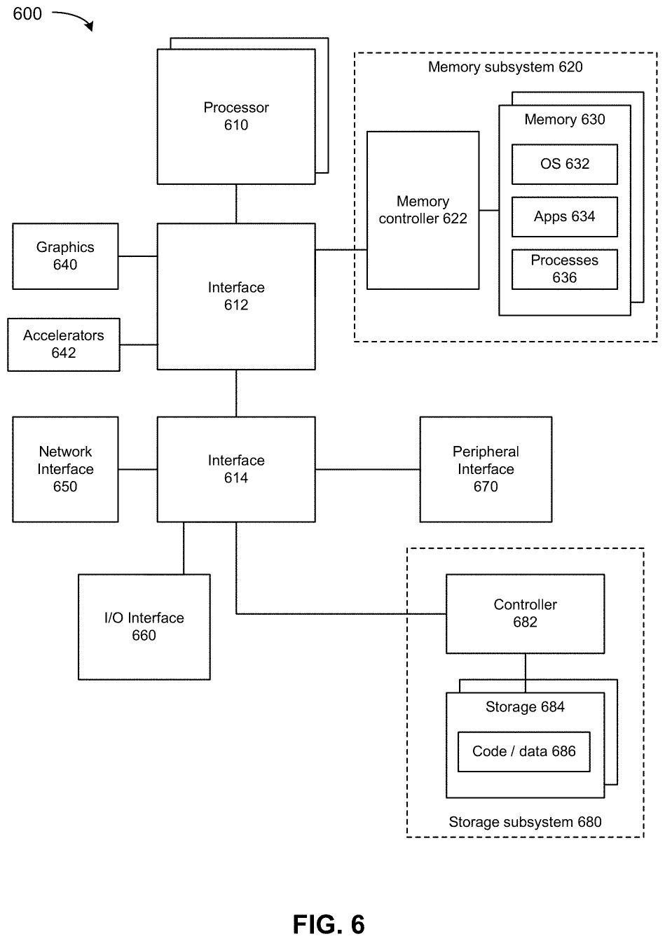

FIG. 6 depicts a system. The system can use embodiments described herein to adjust frequency of operation of a peripheral device interface, system agent, uncore, core, or devices in response to a detected attack or no detected attack. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In some embodiments, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as PCIe, Ethernet, or optical interconnects (or a combination thereof).

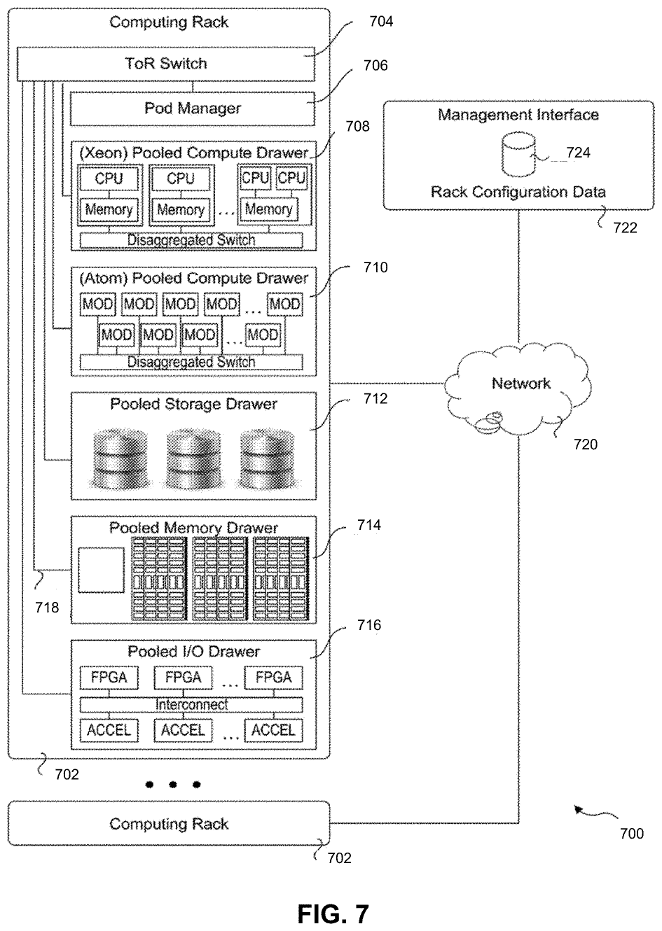

FIG. 7 depicts an environment 700 includes multiple computing racks 702, each including a Top of Rack (ToR) switch 704, a pod manager 706, and a plurality of pooled system drawers. The environment can use embodiments described herein to adjust frequency of operation of a peripheral device interface, system agent, uncore, core, or devices in response to a detected attack or no detected attack. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 708, and Intel® ATOM™ pooled compute drawer 710, a pooled storage drawer 712, a pooled memory drawer 714, and a pooled I/O drawer 716. Each of the pooled system drawers is connected to ToR switch 704 via a high-speed link 718, such as a 40 Gigabit/second (Gb/s) or 100 Gb/s Ethernet link or a 100+Gb/s Silicon Photonics (SiPh) optical link. In some embodiments, high-speed link 718 comprises an 800 Gb/s SiPh optical link.

Multiple of the computing racks 702 may be interconnected via their ToR switches 704 (e.g., to a pod-level switch or data center switch), as illustrated by connections to a network 720. In some embodiments, groups of computing racks 702 are managed as separate pods via pod manager(s) 706. In some embodiments, a single pod manager is used to manage all of the racks in the pod. Alternatively, distributed pod managers may be used for pod management operations.

Environment 700 further includes a management interface 722 that is used to manage various aspects of the environment. This includes managing rack configuration, with corresponding parameters stored as rack configuration data 724. Environment 700 can be used for computing racks.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

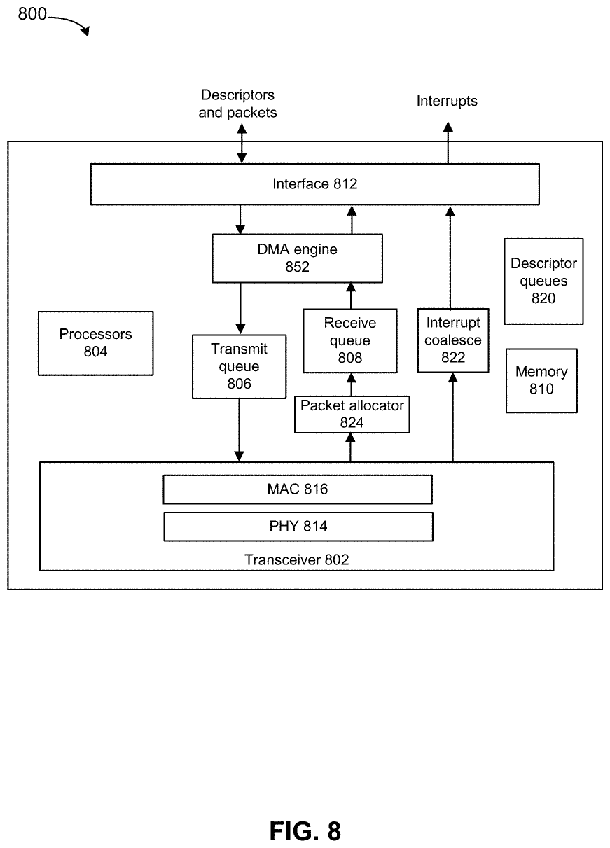

FIG. 8 depicts a network interface that can use embodiments or be used by embodiments. The network interface can use embodiments described herein to adjust frequency of operation of a peripheral device interface, system agent, uncore, core, or devices in response to a detected attack or no detected attack. Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to assemble data to be transmitted into packets, that include destination and source addresses along with network control information and error detection hash values. Processors 804 can be any a combination of a: processor, core, graphics processing unit (GPU), field programmable gate array (FPGA), application specific integrated circuit (ASIC), or other programmable hardware device that allow programming of network interface 800. For example, processors 804 can provide for identification of a resource to use to perform a workload and generation of a bitstream for execution on the selected resource. For example, a “smart network interface” can provide packet processing capabilities in the network interface using processors 804.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

In some examples, processors 804 can perform one or more of: large receive offload (LRO), large send/segmentation offload (LSO), TCP segmentation offload (TSO), Transport Layer Security (TLS) offload, receive side scaling (RSS) to allocate a queue or core to process a payload. LRO can refer to reassembling incoming network packets and transfer packet contents (e.g., payloads) into larger contents and transferring the resulting larger contents but fewer packets for access by the host system or a VEE.

LSO can refer to generating a multipacket buffer and providing content of the buffer for transmission. A host device can build a larger TCP message (or other transport layer) (e.g., 64 KB in length) and processors 804 can segment the message it into smaller data packets for transmission.

TLS is defined at least in The Transport Layer Security (TLS) Protocol Version 1.3, RFC 8446 (August 2018). TLS offload can refer to offload of encryption or decryption of contents in accordance with TLS in processors 804. Network interface 800 can receive data for encryption and perform the encryption of data prior to transmission of encrypted data in one or more packets. Network interface 800 can receive packets and decrypt content of packets prior to transfer of decrypted data to a host system. In some examples, any type of encryption or decryption be performed such as but not limited to Secure Sockets Layer (SSL).

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes a method that includes altering a frequency of operation of a peripheral device interface between a network interface card and a processor based on detection of a traffic violation.

Example 2 includes any example and includes detecting a traffic violation based on detection of IP packet fragments, wherein altering a frequency of operation of a peripheral device interface between a network interface card and a processor based on detection of a traffic violation comprises reducing a frequency of operation of a peripheral device interface between a network interface card and a processor based on detection of a traffic violation.

Example 3 includes any example, wherein IP packet fragments comprise one or more of: IP packet fragments that are incomplete packets, IP packet fragment that are too small, IP packet fragments that result in excessive packets, or IP packet fragmentation buffer being full.

Example 4 includes any example, wherein the detecting a traffic violation based on detection of IP packet fragments comprises detecting a traffic violation based on detection of IP packet fragments at one or more of: a network appliance, the network interface card, uncore, system agent, operating system, application, or a computing platform.

Example 5 includes any example, wherein the peripheral device interface comprises one or more of: a system agent, an uncore, a bus, peripheral component interconnect express (PCIe) interface, and a cache.

Example 6 includes any example, wherein the peripheral device interface is part of a system on a chip (SoC) and the SoC includes one or more of: a core, system agent, or uncore.

Example 7 includes any example, wherein the processor comprises one or more of: a core, accelerator, or graphics processing unit (GPU).

Example 8 includes any example, wherein altering a frequency of operation of a peripheral device interface between a network interface card and a processor based on detection of a traffic violation comprises increasing a frequency of operation of the peripheral device interface based on one or more of: management of the traffic violation at the processor or not detecting a traffic violation and increasing a frequency of operation of the processor can occur if a power budget, allocated for the processor and the peripheral device interface, permits the increasing the frequency of operation of the processor.

Example 9 includes any example, wherein altering a frequency of operation of a peripheral device interface between a network interface card and a processor based on detection of a traffic violation comprises: altering a frequency of a clock provided to circuitry other than cores based on network traffic.

Example 10 includes any example, and includes a non-tangible computer-readable medium comprising instructions stored thereon, that if executed by one or more processors, cause the one or more processors to: detect for traffic violations based on detection of IP packet fragments and reduce a frequency of operation of a peripheral device interface between a network interface card and a processor based on detection of a traffic violation.

Example 11 includes any example, wherein IP packet fragments comprise one or more of: IP packet fragments that are incomplete packets, IP packet fragment that are too small, IP packet fragments that result in excessive packets, or IP packet fragmentation buffer being full.

Example 12 includes any example, and includes instructions stored thereon, that if executed by one or more processors, cause the one or more processors to: detect traffic violations based on detection of IP packet fragments at one or more of: a network appliance, the network interface card, uncore, system agent, operating system, application, or a computing platform.

Example 13 includes any example, wherein the peripheral device interface comprises a system agent or an uncore.

Example 14 includes any example, wherein the peripheral device interface comprises a bus, peripheral component interconnect express (PCIe) interface, and a cache.

Example 15 includes any example, wherein the processor comprises a core, accelerator, or graphics processing unit (GPU).

Example 16 includes any example, and includes instructions stored thereon, that if executed by one or more processors, cause the one or more processors to: increase a frequency of operation of the peripheral device interface based on one or more of: management of traffic violations at a core or not detecting a traffic violation.

Example 17 includes any example, and includes instructions stored thereon, that if executed by one or more processors, cause the one or more processors to: increase a frequency of operation of the processor if a power budget for the peripheral device interface and the processor permits the increasing the frequency of operation of the processor.

Example 18 includes any example, and includes an apparatus comprising: at least one core; a system agent coupled to receive packets from a network interface card and provide the received packet for processing by a core; and a power manager to: reduce a frequency of operation of the system agent based on a request, wherein the request is based on detection of a traffic violation.

Example 19 includes any example, and includes a processor to: detect for traffic violations based on detection of IP packet fragments, wherein IP packet fragments comprise one or more of: IP packet fragments that are incomplete packets, IP packet fragment that are too small, IP packet fragments that result in excessive packets, or IP packet fragmentation buffer being full.

Example 20 includes any example, and includes a processor to increase a frequency of operation of the system agent based on one or more of: management of traffic violations at a core or not detecting a traffic violation and request the power manager to increase a frequency of operation of the system agent.

What is claimed is:

1. A method comprising:
altering a frequency of operation of a peripheral device interface between a network interface card and a processor based on detection of a traffic violation.

2. The method of claim 1, comprising detecting a traffic violation based on detection of IP packet fragments, wherein:
altering a frequency of operation of a peripheral device interface between a network interface card and a processor based on detection of a traffic violation comprises reducing a frequency of operation of a peripheral device interface between a network interface card and a processor based on detection of a traffic violation.

3. The method of claim 2, wherein IP packet fragments comprise one or more of: IP packet fragments that are incomplete packets, IP packet fragment that are too small, IP packet fragments that result in excessive packets, or IP packet fragmentation buffer being full.

4. The method of claim 2, wherein the detecting a traffic violation based on detection of IP packet fragments comprises detecting a traffic violation based on detection of IP packet fragments at one or more of: a network appliance, the network interface card, uncore, system agent, operating system, application, or a computing platform.

5. The method of claim 1, wherein the peripheral device interface comprises one or more of: a system agent, an uncore, a bus, peripheral component interconnect express (PCIe) interface, and a cache.

6. The method of claim 1, wherein the peripheral device interface is part of a system on a chip (SoC) and the SoC includes one or more of: a core, system agent, or uncore.

7. The method of claim 1, wherein the processor comprises one or more of: a core, accelerator, or graphics processing unit (GPU).

8. The method of claim 1, wherein altering a frequency of operation of a peripheral device interface between a network interface card and a processor based on detection of a traffic violation comprises increasing a frequency of operation of the peripheral device interface based on one or more of: management of the traffic violation at the processor or not detecting a traffic violation and comprising:
increasing a frequency of operation of the processor if a power budget, allocated for the processor and the peripheral device interface, permits the increasing the frequency of operation of the processor.

9. The method of claim 1, wherein altering a frequency of operation of a peripheral device interface between a network interface card and a processor based on detection of a traffic violation comprises:
altering a frequency of a clock provided to circuitry other than cores based on network traffic.

10. A non-tangible computer-readable medium comprising instructions stored thereon, that if executed by one or more processors, cause the one or more processors to:
detect for traffic violations based on detection of IP packet fragments and
reduce a frequency of operation of a peripheral device interface between a network interface card and a processor based on detection of a traffic violation.

11. The computer-readable medium of claim 10, wherein IP packet fragments comprise one or more of: IP packet fragments that are incomplete packets, IP packet fragment that are too small, IP packet fragments that result in excessive packets, or IP packet fragmentation buffer being full.

12. The computer-readable medium of claim 11, comprising instructions stored thereon, that if executed by one or more processors, cause the one or more processors to:
detect traffic violations based on detection of IP packet fragments at one or more of: a network appliance, the network interface card, uncore, system agent, operating system, application, or a computing platform.

13. The computer-readable medium of claim 10, wherein the peripheral device interface comprises a system agent or an uncore.

14. The computer-readable medium of claim 10, wherein the peripheral device interface comprises a bus, peripheral component interconnect express (PCIe) interface, and a cache.

15. The computer-readable medium of claim 10, wherein the processor comprises a core, accelerator, or graphics processing unit (GPU).

16. The computer-readable medium of claim 10, comprising instructions stored thereon, that if executed by one or more processors, cause the one or more processors to:
increase a frequency of operation of the peripheral device interface based on one or more of: management of traffic violations at a core or not detecting a traffic violation.

17. The computer-readable medium of claim 10, comprising instructions stored thereon, that if executed by one or more processors, cause the one or more processors to:
increase a frequency of operation of the processor if a power budget for the peripheral device interface and the processor permits the increasing the frequency of operation of the processor.

18. An apparatus comprising:
at least one core;
a system agent coupled to receive packets from a network interface card and provide the received packets for processing by a core; and
a power manager to:
reduce a frequency of operation of the system agent based on a request, wherein the request is based on detection of a traffic violation.

19. The apparatus of claim 18, comprising a processor to:
detect for traffic violations based on detection of IP packet fragments, wherein IP packet fragments comprise one or more of: IP packet fragments that are incomplete packets, IP packet fragment that are too small, IP packet fragments that result in excessive packets, or IP packet fragmentation buffer being full.

20. The apparatus of claim 18, comprising a processor to
increase a frequency of operation of the system agent based on one or more of: management of traffic violations at a core or not detecting a traffic violation and
request the power manager to increase a frequency of operation of the system agent.
